(19) United States
(12) Patent Application Publication
(10) Pub. No.: US 2018/0052438 A1
(43) Pub. Date: Feb. 22, 2018

(54) SYSTEMS AND METHODS FOR POSITION SAMPLE CORRELATION

(71) Applicant: Curt G. Joa, Inc., Sheboygan Falls, WI (US)

(72) Inventor: SEAN P. FOLLEN, Cedar Grove, WI (US)

(73) Assignee: Curt G. Joa, Inc., Sheboygan Falls, WI (US)

(21) Appl. No.: 15/681,049

(22) Filed: Aug. 18, 2017

Related U.S. Application Data
(60) Provisional application No. 62/376,748, filed on Aug. 18, 2016.

(51) Int. Cl. G05B 19/05

(52) U.S. Cl. CPC G05B 19/056; G05B 2219/1185

(57) ABSTRACT

Systems and methods for position sample correlation, wherein a data sample is preferably processed by one or more independent programmable logic controllers (PLCs) and correlated to a servo position from a motion control processor with very high accuracy.

### RELATED APPLICATIONS

This application claims the benefit of co-pending U.S. Provisional Patent Application Ser. No. 62/376,748, filed 18 Aug. 2016.

### BACKGROUND OF THE INVENTION

This invention relates to processing webs of material for use in disposable products such as diapers and sanitary napkins. Although the description provided relates to diaper manufacturing, the apparatus and method are easily adaptable to other applications.

Generally, diapers comprise an absorbent insert or patch and a chassis, which, when the diaper is worn, supports the insert proximate a wearer's body. Additionally, diapers may include other various patches, such as tape tab patches, reusable fasteners and the like. The raw materials used in forming a representative insert are typically cellulose pulp, tissue paper, poly, nonwoven web, acquisition, and elastic, although application specific materials are sometimes utilized. Usually, most of the insert raw materials are provided in roll form, and unwound and applied in assembly line fashion.

In the creation of a diaper, multiple roll-fed web processes are typically utilized. To create an absorbent insert, cellulose pulp is unwound from the provided raw material roll and pulverized by a pulp mill. Alternatively and ever increasingly, super absorbent polymers are used in combination with, or in lieu of, pulverized pulp. Discrete pulp cores are formed by a core forming assembly and placed on a continuous tissue web.

Optionally, super absorbent powder may be added to the pulp core. The tissue web is wrapped around the pulp core. The wrapped core is debulked by proceeding through a calendar unit, which at least partially compresses the core, thereby increasing its density and structural integrity. After debulking, the tissue-wrapped core is passed through a segregation or knife unit, where individual wrapped cores are cut. The cut cores are conveyed, at the proper pitch, or spacing, to a boundary compression unit.

The diaper is built by sandwiching the formed core between a backsheet and a topsheet, and the combined web receives ears for securing the diaper about the waist of a baby.

Diapers are typically formed in a machine direction in a generally flat condition. Formed diapers require folding both longitudinally to tuck the ears and associated tape or hook applicators into the diaper, and also cross-folded generally at a crotch region to stack the diapers prior to packaging.

The folded product is then passed downstream to a packaging machine where the diapers are stacked and packaged and shipped for sale.

As modern processing machinery becomes faster, more automated, and more efficient, machines are being provided with sensing and vision capabilities to optimize production, correct production defects, and reject products that do not meet quality tolerances for instance. Measurements of the machine operating parameters are taken and analyzed very frequently.

In some instances, measurements are being taken, and the machinery adjusted for optimization, many times per second. Parameters such as bond strength between two components of a disposable product can be altered by varying how the machinery is set up. Computers are coupled to the sensing equipment, and controllably linked to the diaper production machinery to adjust the machinery for optimized run and production conditions.

Sampling intervals in modern sensors is often very quick, on the order of fractions of a millisecond. Other sensor sampling frequencies are on the order of a or a few milliseconds or more.

Because the sampling intervals are so quick, in certain applications, such as in bonding applications, it is difficult to know when to sample load cell data (or which data subset of a larger set) to focus on, analyze, or correct machine operation based upon the sensed data. For instance, in bonding applications, it is desired to use force measurements from, the particular time period when a bonding unit (servo driven for instance) is in a proper position to make a bond. Force measurements are being constantly analyzed and transmitted; and machine action items or adjustments, should be based upon measurements taken during the critical bonding period and perhaps not based upon extraneous data collected during non-bonding periods.

Initial effort was to sample all the time. This had accuracy issues, however. Also, sampling based on a proximate position has been attempted but it is difficult to adjust length/time of the sample area.

### SUMMARY OF THE INVENTION

A novel disposable product manufacturing method, and an apparatus (system) for forming disposable products is disclosed. The system acquires a first data series at a first rate. For instance, the system is equipped with sensors, and acquires measurements such as force measurements every 0.5 ms.

The first data series can be acquired from a feedback device, such as load cell or tension transducer or temperature sensor or flow sensor or any other sensor or detector designed to provide feedback data used by programmable automation control or motion control systems typically used in high speed automated machinery such as paper converting, web processing, laminating, winding, unwinding systems.

High-capacity-high-performance automation or motion control systems may comprise one or more of PLC's (programmable logic controllers), sPLC's (safety programmable logic controllers) PLR's (programmable logic relays), RTU's (remote terminal units), or DCS (distributed control system) for example. Programmable limit switches (PLS) could be a section designed into a PLC, and in the case of the present invention, could identify when a machine component of interest (e.g., a bonding system) is in a position of interest for data. to be collected. An example of a PLS could be on/off for an adhesive glue gun, as such features are often triggered intermittently during production runs. As machine speeds ramp up, it may be necessary to adjust the timing of such features, because the target for the adhesive will be moving quicker, so the glue gun will be operational for less time. Therefore, there is a need to alter the on/off because of the time (speed) changes, and additional time is required to communicate with and operate the intermittent features.

The system is equipped with additional sensors, and acquires measurements such as axial position measurements of rotating bodies (equipment) of interest at a second rate, for instance every 20 ms. The system is particularly adapted to correlate to identify position or positions of interest of the rotating body (e.g., a bonding point on a rotating drum) and accept force measurements acquired from the system during the period. in time during which the rotating body is in the position of interest. If, due to any differences in rate of measurements between the first data series and the second series, the system does not obtain a position measurement at a position of interest, a third data series (for example, a combination of force and position) can be created comprising said first data series and an interpolation of said second data series.

The third data series can control an optimization step on a disposable product manufacturing line. Optimization steps can be adjustment of machine operating parameters such as applied forces, gap spacing, speeds, rotational velocities or the like. For instance, the optimization step can be adjusting a gap spacing between an anvil and horn in a bonding unit. Such optimization can therefore monitor the force on one or both of the anvil or horn, and adjust the gap between the two to increase or decrease bond strength into a desired range.

In an alternative embodiment, a first data series can be acquired at a first rate, and a second data series can also be acquired at said first rate, in which case the interpolation step could be unnecessary.

The disclosed methods correlate a first data series, such as a force window, with a correct subset of the position readings of a rotating body. Force and position data is created from force and time data, and position and time data, where the force readings and position readings are taken at different times or time intervals. The disclosed inventions overcome the shortcomings of the state-of-the-art where scan times of various control systems as previously mentioned may be in the range of 5-20 milliseconds (20 milliseconds is typical with large scale complex machine systems) and specific feedback data that needs to be reliably collected occurs in 1-5 millisecond windows as can be the case when making thousands of products per minute or processing webs at speeds exceeding 500 meters per minute.

In independent programmable logic controllers (PLCs), a data sample is preferably taken and correlated to a servo position from a different PLC with very nigh accuracy.

### BRIEF DESCRIPTION OF THE DRAWINGS

FIG. 1 is an illustration of a first source code block according to the present invention;

FIG. 2 is an illustration of a second source code block according to the present invention;

FIG. 3 is a depiction of an example sampling and interpolation according to the present invention;

FIG. 4 is a table showing the parameters of a first code block;

FIG. 5 is a table showing the parameters of a second code block;

FIGS. 6 and 7 are graphs of data according to the present invention;

FIGS. 8 and 9 are a schematic view of a logic sequence of the present invention;

FIG. 10 is a schematic view of a portion of a disposable product manufacturing system of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

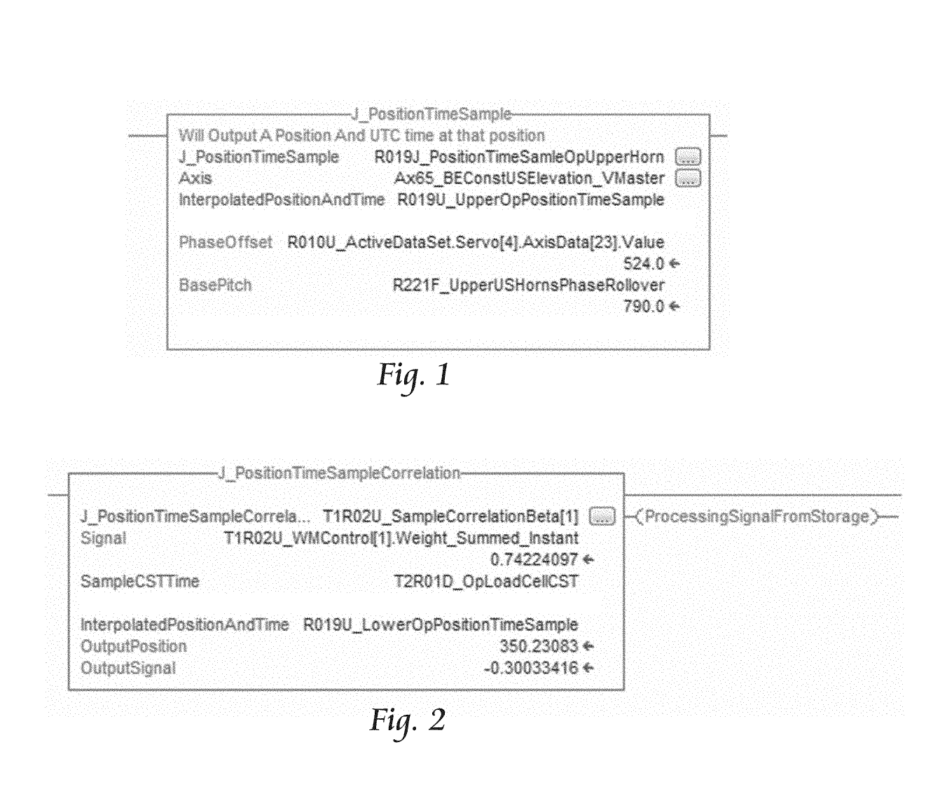

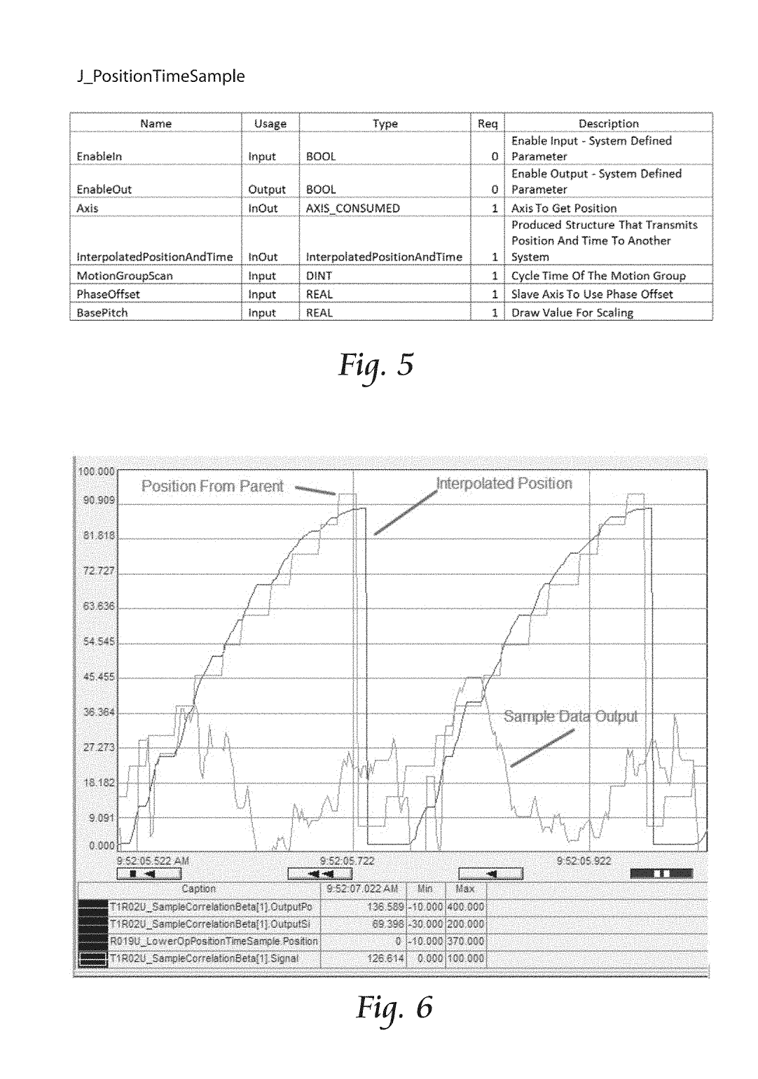

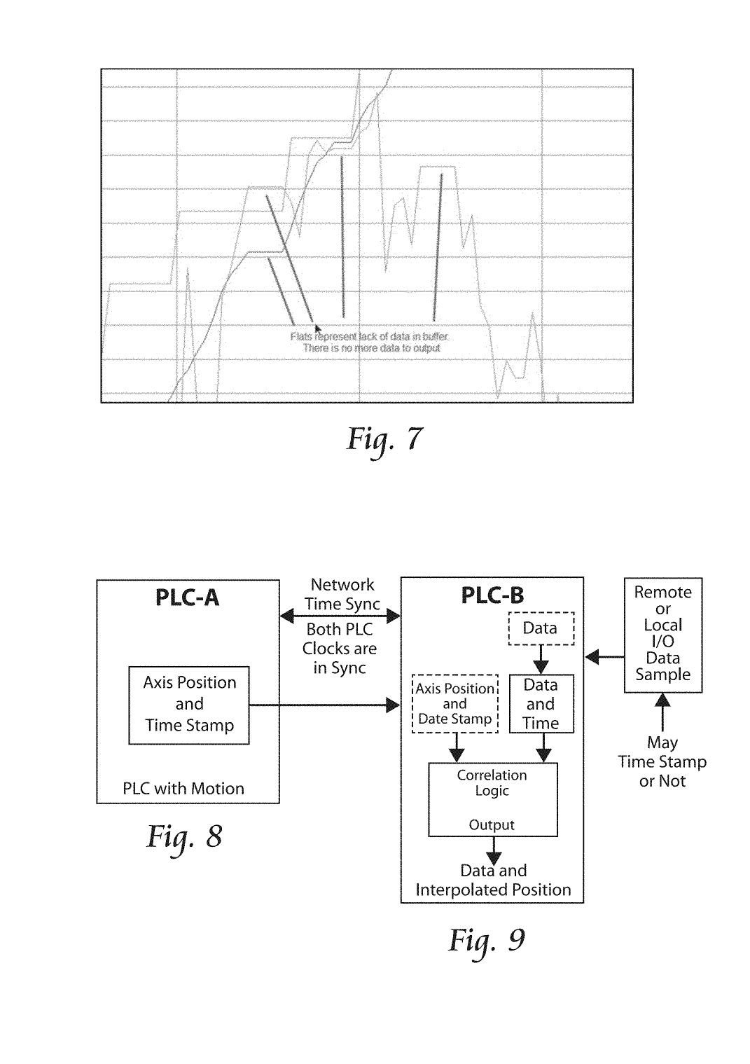

There are two blocks that are employed according to the present invention. J_PositionTimeSample block (FIG. 1 and FIG. 5) sends an axis position and time stamp to another PLC. The receiving PLC uses J_PositionTimeSampleCorrelation block (FIG. 2 and FIG. 4) to receive data and time. That data and time are stored and then with the axis position and time stamp the interpolated position is calculated and output. It is understood that time stamp in this context could also mean a sync count, or other relational parameter not based on time.

In a parent PLC (not shown) that has the axis data from the J_PositionTimeSample block (FIG. 1) will grab the local time, for example Central Standard Time (CST), and get the interpolated position of that axis at that moment in time. This time and position will be sent over to a sample PLC for correlation.

Concurrently, in the sample PLC data is input into the plc via analog signal or other analog value. That value upon receiving is time stamped if it is not already. Then that data is presented to the correlation block. It is expected that many samples will be taken and stored in a first in first out buffer array.

When at least two positions and times are received from the parent PLC, preferably all the samples in between the received times are interpolated to have new positions that would correspond to the time in which the sample was taken. Then the block will output the samples with a position of the axis when the sample was received.

Preferably, the J_PositionTimeSample block (FIG. 1) is scanned at a rate of, for example, 20 ms. The Sample Correlation PLC stamps input data at a rate of, for example, 0.5 ms and then the J_PositionTimeCorrelation block (FIG. 2) saves the data. at a rate of 2 ms. Therefore, up to 10 data points may be buffered or stored before a new position and time are received. After a new position and time are received, each scan preferably produce a new correlated sample with position and is output.

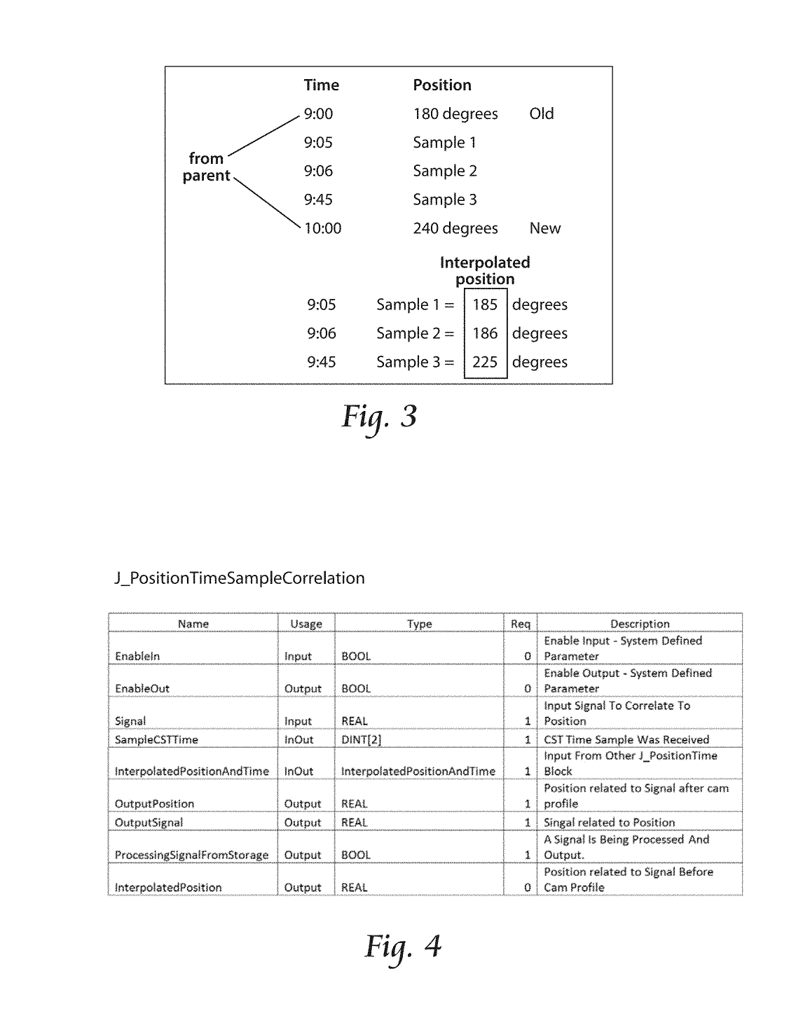

Referring now to FIG. 3, a depiction of an example sampling and interpolation according to the present invention is shown. In this example, position measurements are not available at each time, but based on measured position readings at known time stamps, positions at other times can be interpolated.

Referring now to FIGS. 8 and 9, the goal of this logic is to take data samples, such as force from a load cell, analog position of a dancer or any other type of feedback measuring device and relate that data to an Axis position, or an angular position of an object controlled by a drive/servo system. That axis position may be somehow connected to that data sample physically. In an exemplary embodiment, a drive system is moving a roll that has a load cell attached. Positions of interest include sampling load cell data if the axis is in the correct position window, such that work is being done, and that work can be optimized. Load cell data related to positions outside a position of interest can be discarded if desired. Referring specifically now to FIGS. 8 and 9, PLC-A holds the axis and time data that is desired to relate to the data sample. PLC-A takes the current axis position and links that axis position to the clock time the axis was in that position, and then communicates with PLC-B. An axis position and the time of that position is retrieved by PLC-A and that this is the desired axis position to be compared with the data sample provided by the I/O. PLC-A provides Position and Time to PLC-B, also PLC-B receives a data sample such as force data, from the remote or local I/O which is optionally time stamped. Referring now to FIG. 9, PLC-B receives the axis position and time from PLC-A. PLC-B also receives the Data Sample and a time from I/O. If the I/O cannot provide a time then the data is married to a time in logic, because in PLC logic a request can be made for the current time and the PLC will share that time.

It is possible that a plurality of data samples could be received and buffered while waiting for axis position and time data from PLC-A. That data can be output with position while buffering incoming data samples. Both operations happen synchronously. Additionally, in a preferred embodiment, both PLC-A and PLC-B are connected in such a way that their clocks are synchronized. In an alternative embodiment to that shown in FIGS. 8 and 9, this same logic in PLC-A and PLC-B could reside in a single PLC.

The correlation logic then stores or buffers the data sample and interpolates the axis position when that data sample was taken based on the axis position and time from PLC-A. The output is then Interpolated Axis position and the corresponding Data sample. With this output, an optimization step can be performed, such as a machine adjustment towards a target.

For instance, an axis position and time stamp retrieved from PLC-A could be considered a radial position of a first actor on a machine. A data sample from a remote or local I/O could be measured data, such as force, of a second actor on the machine that impacts performance. If the machine senses that it could adjust to optimize performance, such as increasing or decreasing bond strength, PLC-B can generate and adjust a machine parameter to alter measured data towards the machine achieving its targeted bond strength.

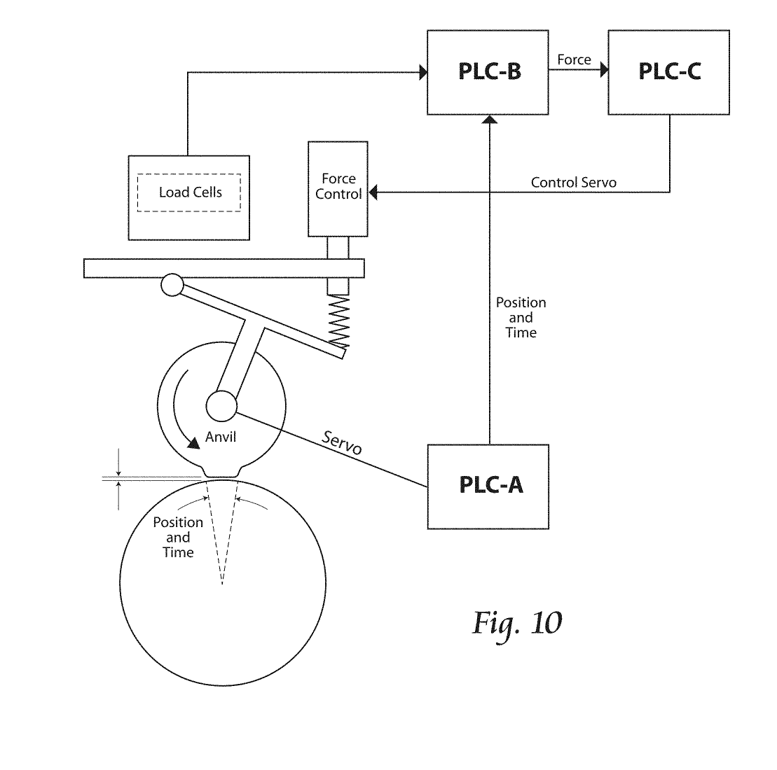

Referring now FIG. 10 is a schematic view of a portion of a disposable product manufacturing system of the present invention. Data is acquired in the form of force from a load cell. However, data could be acquired from any different portion of a disposable product manufacturing system, for instance, analog position of a dancer or any other type of feedback measuring device. In the case of an intermittent operation such as the illustrated intermittent bonder, a position of interest is a time period (and its associated spatial position of a bonder) when a bond is being performed. Other exemplary positions of interest could be chosen based on a machine criteria or material criteria at which time and position is of interest effecting an optimized product value (e.g., bond strength) and machine parameters can be adjusted to alter the measured data towards a target. Readings between bonding events, during trio period of intermittency, can be outside a position of interest. Referring still to FIG. 10, in an exemplary embodiment, we an axis of a rotating body has a load cell for generating data (force) measurements. During bonding, a position of interest is observed, for instance during the moment that actual bonding during an intermittent process is taking place. The act of bonding generates a force that is read at the load cell. A subsequent bonding operation is performed after a period of intermittency, and once again the position of interest arises. Because the bonding period is identified as the period of interest, data during this period is of particular interest. PLC-B is simultaneously receiving constant force readings, and can average those readings. By adding the correlation logic we have married the axis position to the force readings with high precision. In the sequence, the axis position is used to add force samples to our average. If the average force is running low (for instance due to thermal expansion or contraction of components) the system corrects by bringing the anvil in closer (in precise systems, a few microns closer for instance) and the force goes up to achieve a stronger bond. If the average force is too high then the anvil is moved further away (again a few microns in a precise system) to protect the equipment. Although FIG. 10 describes trio process as relating to a bonding unit and gap spacing, alternate systems of the present invention use the same logic in different manufacturing processes. For instance, the same logic can be used to relate web tension to an unwinder to calculate where deformities exist in a material roll. In such an embodiment, in many instances full servo machines are employed and axis positions can be acquired from several units on a machine, and measuring devices on the machine could be compared to an axis position for process optimization.

Feedback data from the bonding system is acquired and optimization control decisions based on the data are performed. In a general sense, data such as a radial position of a first machine actor can be interpolated based on a measured data of a second machine actor, with the second machine actor action impacting optimized performance. Optimized performance (such as a targeted bond strength), or optimized value (such as a force measurement indicative of an optimized value) can be achieved by adjusting a machine parameter. For instance, if the data indicates the bond is within acceptable specifications or trending towards a fault, optimization control decisions can be generated and transmitted to adjust machine operation parameters to alter measured data towards a target.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A method for optimizing performance of a machine comprising:
acquiring a first data series at a first rate;
acquiring a second data series at a second rate;
synchronizing said first and second data series;
calculating a third data series as a combination of said first and said second series comprising said first data series and an interpolation of said second data series;
adjusting a machine component in response to said third data series.

2. A method according to claim 1, wherein said third data series adjusts an operation on a disposable product manufacturing line.

3. A method according to claim 2 wherein said operation is a bonding unit.

4. A method according to claim 3, wherein said operation is adjusting a gap spacing between an anvil of said bonding unit and a horn of said bonding unit.

5. A method according to claim 1, said first data series comprising a plurality of force measurements.

6. A method according to claim 1, said second data series comprising a plurality of position measurements of a first component of said machine.

7. A method according to claim 6, said position measurements comprising axial position measurements.

8. A machine for producing disposable product, the machine comprising:
an operating unit for processing a web of material coupled, said operating unit communicatively coupled to a programmable logic controller system;
a sensor for measuring a parameter while said operating unit is at a position of interest, said sensor communicating data from said sensor to said programmable logic controller system;
said programmable logic controller system receiving position data from said operating unit;
said programmable logic controller system adjusting operation of said operating unit in response to measured parameters from said sensor.

9. A method for optimizing performance of a machine comprising:
acquiring a first data series at a first rate;
acquiring a second data series at said first rate;
synchronizing said first and second data series;
calculating a third data series as a combination of said first and said second series comprising said first data series and said second data series;
adjusting a machine component in response to said third data series.
